(19) United States
(12) Patent Application Publication
(10) Pub. No.: US 2011/0258613 A1
(43) Pub. Date: Oct. 20, 2011

(54) SOFTWARE DEBUGGER ACTIVATION BASED ON KEY PERFORMANCE INDICATORS

(75) Inventors: Kulvir Singh Bhogal, Pflugerville, TX (US); Jennifer Elizabeth King, Austin, TX (US); Christina Karen Lauridsen, Austin, TX (US); Robert Ross Peterson, Austin, TX (US)

(73) Assignee: INTERNATIONAL BUSINESS MACHINES CORPORATION, Armonk, NY (US)

(21) Appl. No.: 12/761,390

(22) Filed: Apr. 15, 2010

(51) Int. Cl. G06F 9/44

(52) U.S. Cl. 717/129; 717/127

(57) ABSTRACT

A software debugger is enabled and runs in the background for debugging a computer software program. The target criteria for one or more Key Performance Indicators of interest relating to the program performance are established before the program begins its execution. During execution, the debugger is activated and takes control of the program execution if a Key Performance Indicator meets its established criteria. The execution of the program is paused, and the program enters a debug mode during which an execution state of the program in system memory could be examined and modified. The debugger also provides functions for controlled execution like single-stepping, forwarding and rewinding. A user interface coupled to the debugger allows a user to interact with the debugger and control program execution.

### FIELD OF THE INVENTION

The invention relates generally to computer software development, and more particularly, to a software debugger that is activated to provide program debug data when certain Key Performance Indicators (KPIs) of a software program meet established criteria.

### BACKGROUND

An important step in the process of developing computer software is program debugging. Debugging refers to the identification and removal of errors within a software program, which can be costly and time consuming, depending on the complexity of the software being developed. Accordingly, software debug tools, commonly referred to as debuggers, have been developed to reduce the debug cycle time.

A software debugger typically executes as a self-contained process for controlling the application program under test through operating system primitives designed for that purpose. The debugging application provides utilities to assist a programmer in locating and correcting program errors. For instance, most debuggers provide control functions for stepping through the executing code of a program, monitoring the status of input/output ports, and for monitoring and modifying the contents of memory locations and central processing unit registers.

The debugging application also allows a software developer to set a breakpoint against a line of code in a program under test, which causes the execution of the program to pause when it reaches the target line of code. During the pause, program state data like the contents of the program variables, local storage and system registers may be examined by the developer to identify potential errors in the code. This is very useful when a developer or tester is interested in the program state around pre-determined lines of code. However, a breakpoint utility is not helpful when a run-time error exists in the program and the developer does not know the approximate lines of code that might cause the run-time problem. As a result, the developer cannot rely on breakpoints to pause the execution of the program and look for a possible cause of the error in the source code of the program.

From the foregoing, it is appreciated that there still exists a need for activating a program debugger during execution without having to know an approximate location for setting a code breakpoint as currently practiced.

### SUMMARY

In accordance with aspects of the invention, an exemplary embodiment of a method, system and computer program product for debugging a computer program is described. The method comprises establishing target values for one or more Key Performance Indicators related to the performance of the program, enabling a debugger coupled to the program, and activating the debugger when a Key Performance Indicator reaches its established target value during execution of the program.

The details of the preferred embodiments of the invention, both as to its structure and operation, are described below in the Detailed Description section in reference to the accompanying drawings. The Summary is intended to identify key features of the claimed subject matter, but it is not intended to be used to limit the scope of the claimed subject matter.

### BRIEF DESCRIPTION OF THE DRAWINGS

FIG. 1 is a block diagram of a typical data processing system in which aspects of the present invention might be implemented.

FIG. 2 is a block diagram illustrating the components in the memory unit of the data processing system of FIG. 1 for providing aspects of the invention, according to one exemplary embodiment of the invention.

FIG. 3 is a block diagram showing another exemplary embodiment of the invention that includes a user interface to allow a user to interact with the software debugger.

FIG. 4 is a flow chart representing a high level process for activating a software debugger based on one or more Key performance Indicators, according to an exemplary embodiment of the invention.

FIG. 5 is a flow chart representing a detailed process for activating a software debugger based on one or more Key performance Indicators, according to another exemplary embodiment of the invention.

FIG. 6 is a block diagram showing an exemplary user interface for allowing a user to examine debug information and control the execution of a program in debug mode, according to aspects of the invention.

FIG. 7 illustrates an example of a user interface window for displaying information concerning a program's Key Performance Indicators by a debugger user interface, according to aspects of the invention.

FIG. 8 illustrates an example of a user interface window for displaying information concerning a program's stack trace and running threads by a debugger user interface, according to aspects of the invention.

FIG. 9 illustrates an example of a user interface window for displaying information concerning a program's memory state and variable values by a debugger user interface, according to aspects of the invention.

FIG. 10 illustrates an example of a user interface window for displaying information concerning a program's source code by a debugger user interface, according to aspects of the invention.

### DETAILED DESCRIPTION OF THE INVENTION

The invention relates to a method, system and computer program product for activating a software debugger during the execution of a program when a key performance indicator of the program meets certain desired criteria. The execution of the program is paused and enters a debug mode during which a software developer may examine system and program data relating to the program execution at the time when the key performance indicator reached its target value and triggered the debugger.

As will be appreciated by one skilled in the art, aspects of the present invention may be embodied as a method, system or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures described below illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

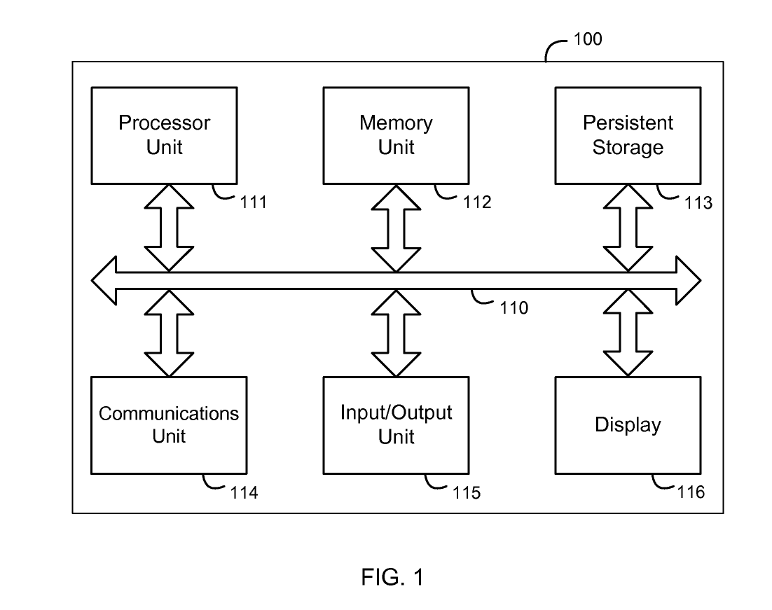

Referring now to the drawings and in particular to FIG. 1, there is depicted a block diagram of a data processing system in which aspects of the present invention might be implemented. As shown, a data processing system 100 includes a processor unit 111, a memory unit 112, a persistent storage 113, a communications unit 114, an input/output unit 115, a display 116 and a system bus 110. Computer programs are typically stored in the persistent storage 113 until they are needed for execution, at which time the programs are brought into the memory unit 112 so that they can be directly accessed by the processor unit 111. The processor unit 111 selects a part of memory unit 112 to read and/or write by using an address that the processor 111 gives to memory 112 along with a request to read and/or write. Usually, the reading and interpretation of an encoded instruction at an address causes the processor 111 to fetch a subsequent instruction, either at a subsequent address or some other address. The processor unit 111, memory unit 112, persistent storage 113, communications unit 114, input/output unit 115, and display 116 interface with each other through the system bus 110.

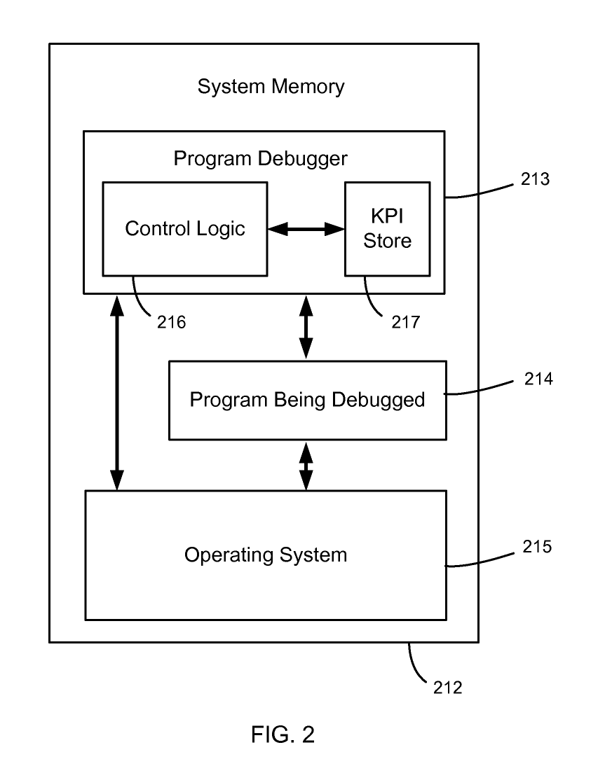

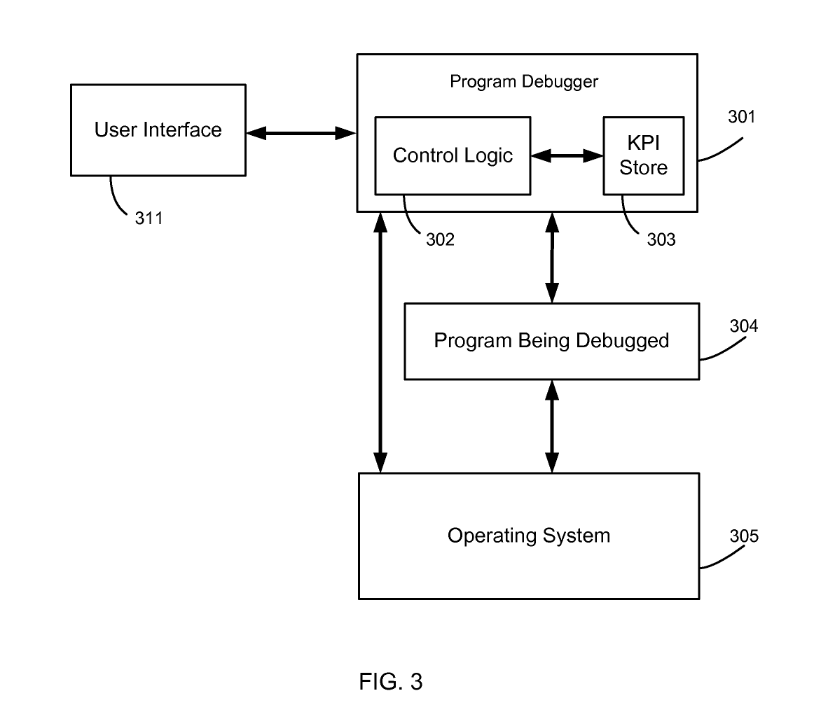

With reference now to FIG. 2, there is illustrated a block diagram of the contents within the system memory unit 112 from FIG. 1, in accordance with an exemplary embodiment of the present invention. As shown, the system memory 212 includes a program debugger 213, an application program 214 that is being debugged, and an operating system 215. The application program 214 is controlled and monitored by the program debugger 213 when the debugger 213 is active. The program debugger 213 contains a debugger control logic 216 and a Key Performance Indicator (KPI) store 217. The debugger control logic 216 includes functional components for controlling the behavior of debugger 213 and performing the operations associated with the debugger 213 as described below in reference to FIGS. 3-8. In the exemplary embodiments of the invention, the debugger control logic 216 may be implemented as sequences of computer instructions that are executed by the computer on which the debugger 213 is running.

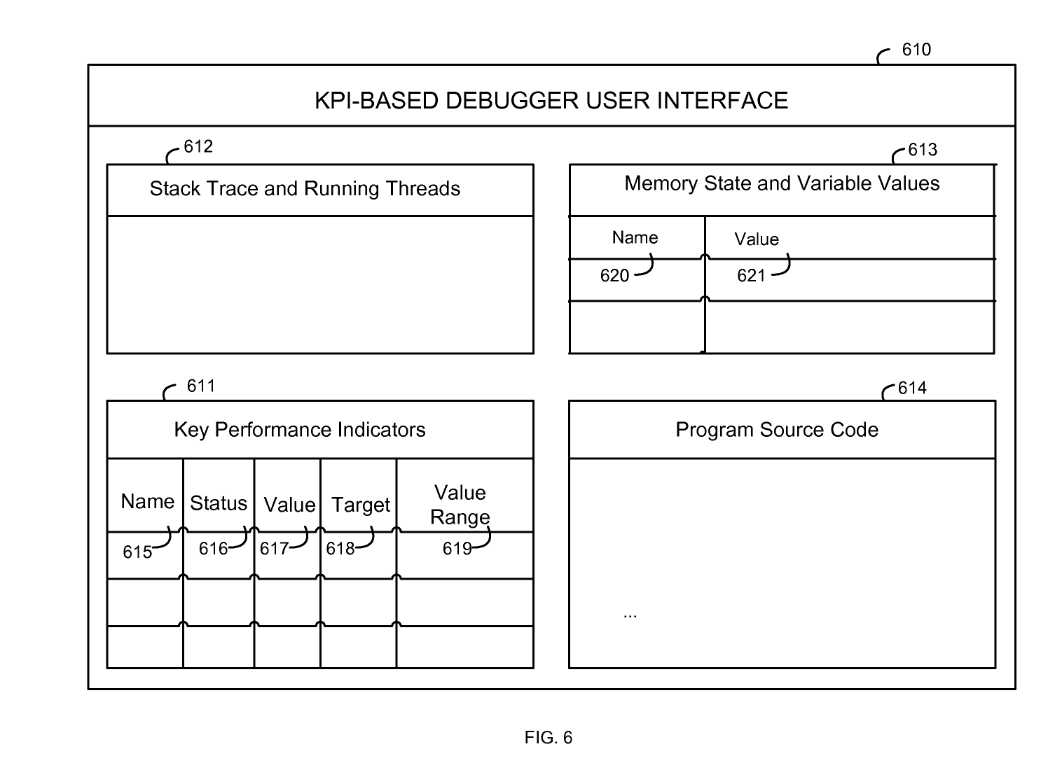

The Key Performance Indicator store 217 maintains information about key performance indicators of the application program 214 that are of interest to the user. This information includes relevant indicator parameters and predetermined performance criteria that would trigger the program debugger 213 when the particular indicator meets the established criteria. In the exemplary embodiments of the invention, the Key Performance Indicator store 217 includes, for each performance indicator of interest, an indicator name, a normal operating range and a target value that the program debugger would be activated when the indicator reaches the target value. An example of the type of information associated with some key performance indicators is described below with reference to FIG. 6.

FIG. 3 is a block diagram showing another exemplary embodiment of the invention that includes a software debugger with an interface to allow a user to interact with the debugger. Similar to the embodiment of a debugging system shown in FIG. 2, the exemplary embodiment in FIG. 3 includes a program being debugged 304 that is in communication with an operating system 305 during the execution of the program. A program debugger 301 runs in the background while the program 304 is being executed by the computer. The program debugger 301 further interacts with the operating system 305 and monitors the execution of the program 304. The control logic 302 and Key Performance Indicator store 303 of the program debugger 301 have previously been described with reference to FIG. 2.

The program debugger 301 further communicates with a user interface 311 through which a user may specify one or more performance indicators of interest that relate to the execution of the program. These performance indicators might include, among others, system resource measurements and the transactions and processes being handled by the program 304. As examples, the key performance indicators might relate to the processor's throughput (CPU usage), system memory usage, cache utilization, as well as the numbers of data queries, transactions, client requests and server responses processed by the program 304.

In addition, the user interface 311 allows the user to examine contents of the debugged program's variables, memory state and particular lines in the source code of the program 304 for identifying potential causes of program code defects. Through the interface 311, the user may further control the execution of the program 304 using common debug functions such as setting breakpoints in the source code of the program 304, and forwarding or rewinding the execution. Further details on an exemplary user interface 311 are described below with reference to FIGS. 6-10.

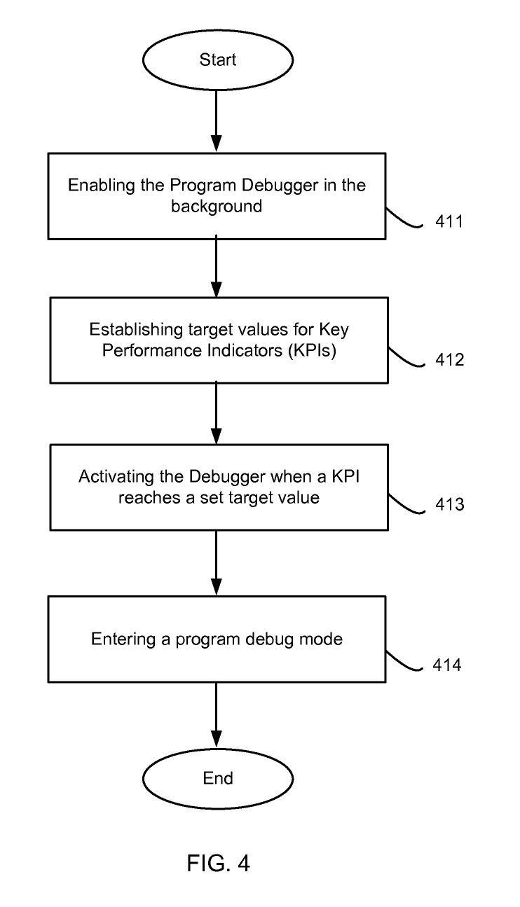

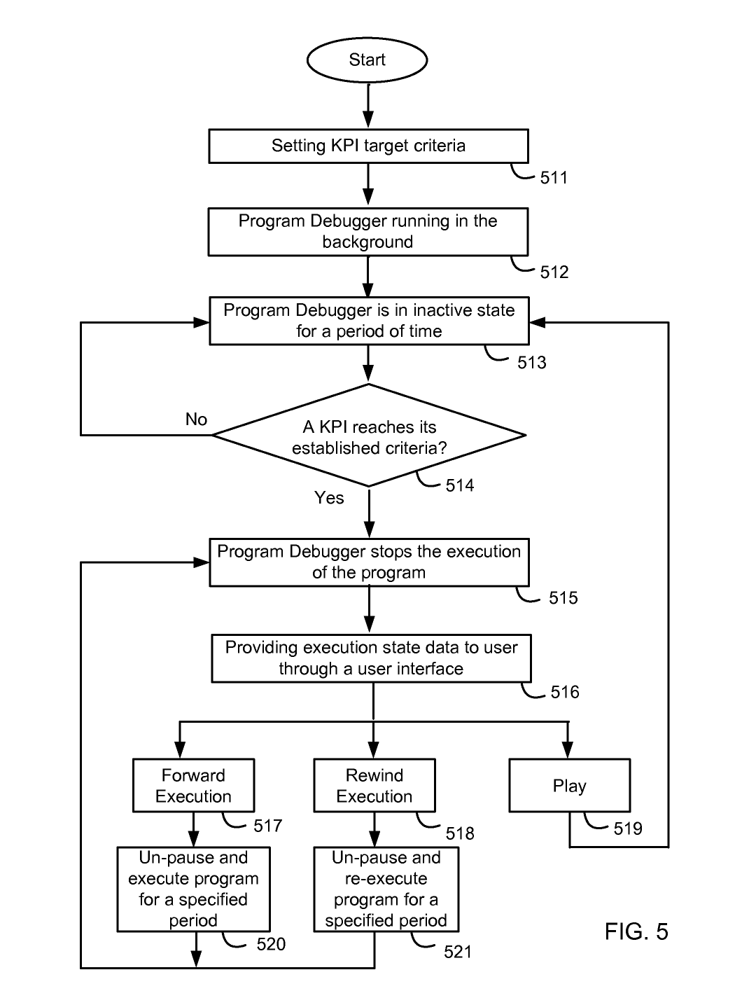

Referring now to FIG. 4 which depicts a high-level flow diagram of a process for activating a program debugger based on one or more Key Performance Indicators, in accordance with an exemplary embodiment of the invention. Starting at block 411, a program debugger is enabled and runs in background mode while the program being debugged is executed by the operating system. At block 412, the target criteria for one or more Key Indicators concerning the performance of the program under test are established. The user might set the performance criteria through the user interface 311, as an example. During the execution of the program, if a Key Performance Indicator meets the respective criteria or target value, then the program debugger is activated and takes over the control of the program execution, per block 413. In effect, the program execution is temporarily paused at the current line of code and the debugger is now in control of the program execution. The process then enters a program debug mode at step 414, which is described below with reference to FIG. 5.

FIG. 5 depicts a flow diagram of a method for activating a software debugger based on one or more Key performance Indicators, in accordance with another exemplary embodiment of the invention. At block 511, the target criteria for one or more Key Performance Indicators concerning the performance of the program are established for observation during the program execution. A Key Performance Indicator might be the rate of the transactions being processed in a transaction-oriented software program such as a database query-processing application. If the application is running in a client-server system, then a Key Performance Indicator might concern the rate of client requests or server responses being processed by the application. Other Key Performance Indicators might relate to the performance or usage of a system resource such as CPU, memory, cache management and network bandwidth.

At block 512, the program debugger is enabled to run in the background of the system while the program under test is being executed. The debugger might be in an inactive mode for some period of time while the program instructions are processed by the computer, as shown in block 513. The debugger continues in this inactive loop as long as no Key Performance Indicator meets its set target criteria, as determined in block 514. When one of the identified Key Performance Indicators meets its target value, the program debugger is triggered and pauses the execution of the program, at block 515. The process next enters a debug mode during which a user could examine a snapshot of the program in its execution state in system memory, per block 516. Using a debugger interface like the one described in FIG. 6, the user might display contents of the data structures used by the program as well as the program source code and system registers at the point when the execution of the program was paused. The user interface 311 allows the user to interact with a target process in terms of the variable names used in the program source file.

In debug mode, the user could execute selected lines of code in the program, re-execute a portion of the code, or continue with the program execution starting from the point in the program where the execution was last paused. A forward mode is shown in block 517 where the program execution is unpaused by the debugger and allowed to run for a period of time as specified by the user (block 520). In the rewind mode shown by block 518, the execution is unpaused by the debugger and the program is re-executed for a time period as specified by the user (block 521). Another option available to the user is to resume the execution of the program starting from the location in the program code where the debugger was activated, as shown by block 519. At that point, the debugger returns to its inactive state, per block 513.

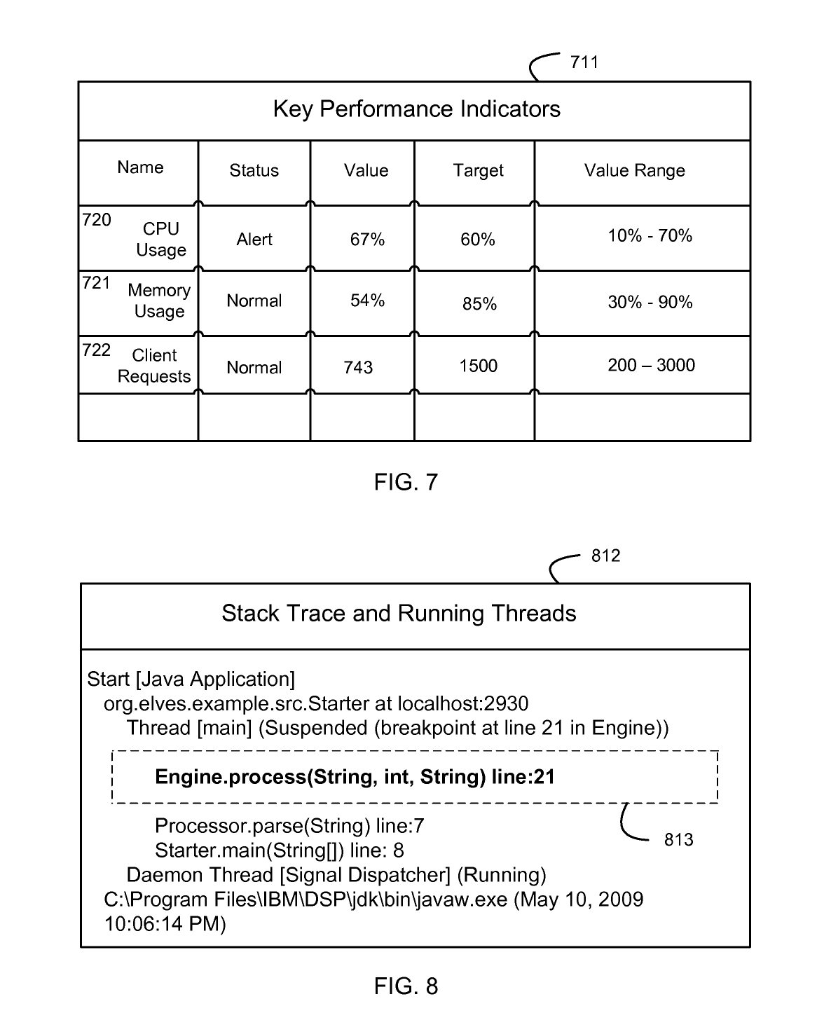

FIG. 6 is a diagram illustrating a user interface screen 610 with relevant information relating to a program execution state that the user might examine in debug mode, according to another exemplary embodiment of the invention. As an example, the KPI-Based Debugger User Interface 610 has four windows for displaying information about the Key Performance Indicators and memory state of the program execution. A window 611 displays specific parameters on a set of Key Performance Indicators of interest such as CPU usage, memory usage and the rate of clients requests being processed by the program. For each indicator, the window 611 includes an indicator name 615, a current status 616, a current value 617, a target value 618 and a value range 619 for the indicator. An example of the contents in window 611 is illustrated in FIG. 7.

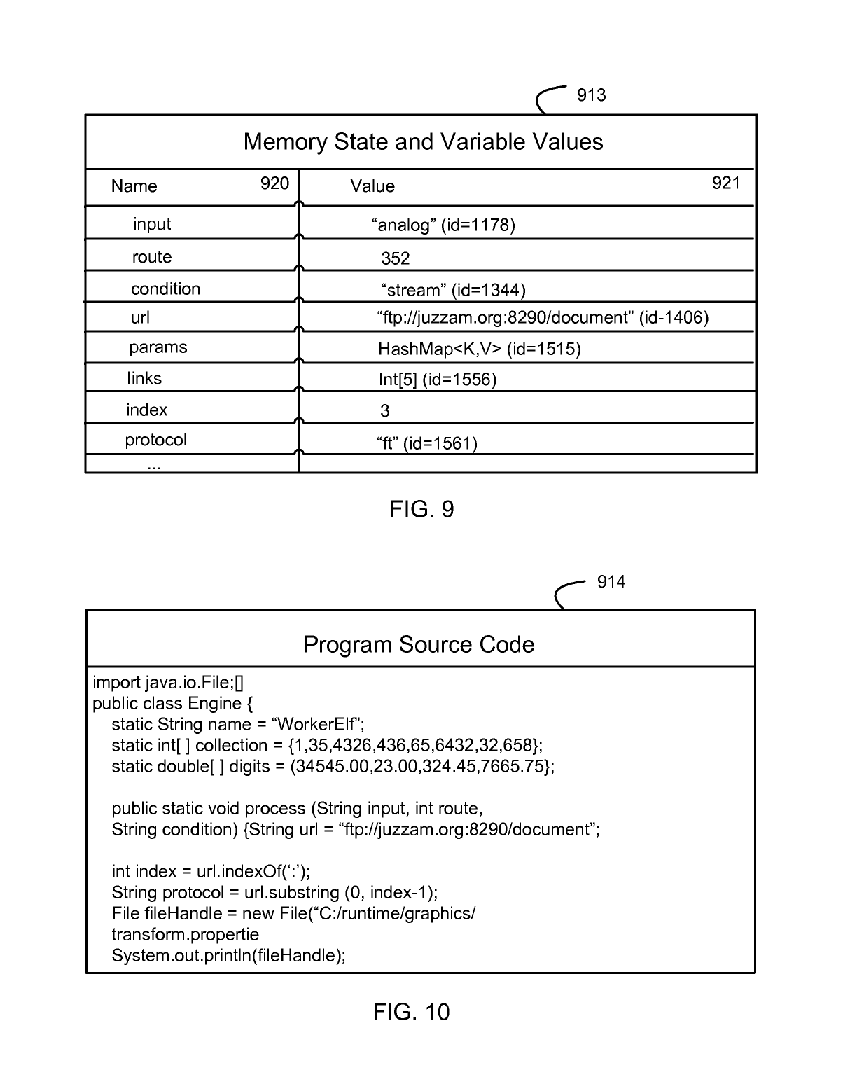

A window 612 of the exemplary user interface screen 610 displays a trace of the program's running threads and memory stacks at the point when one of the Key Performance Indicators reached its target value. Further details of the window 612 are illustrated in FIG. 8. A window 613 of the under interface 610 shows the memory state in terms of the program variable names and their values when the program debugger was activated and program execution was paused by the debugger. The window 613 includes columns 620 and 621 for showing, respectively, the names of the program variables and their values when the debugger was activated. Further details of the window 613 are illustrated in FIG. 9. The exemplary user interface screen 610 further has a window 614 for displaying a portion of the program source code when the debugger was activated. An example of the contents in window 614 is shown in FIG. 10.

FIG. 7 shows an example of the contents displayed in a Key Performance Indicators window 711. The three performance parameters of interest are CPU Usage 720, Memory Usage 721 and Client Requests 722. In this example, the current measurements for the Memory Usage 721 and Client Requests 722 indicators are within their value ranges and have not reached the respective targets. As a result, their status are shown as “Normal”. On the other hand, the current measurement for CPU Usage indicator is 67%, which is above the target value of 60% for this KPI indicator. Accordingly, the status for the CPU Usage indicator 720 is shown as being on “Alert”.

FIG. 8 illustrates an example of the contents displayed in a Stack Trace and Running Threads window 812. The window 812 includes information relating to a program thread what was being processed by the program when the debugger was activated. The window 812 further highlights in a window 813 the particular running thread and code line when a Key Performance Indicator reached its threshold. The corresponding program source code is displayed by the user interface 610 in window 914 of FIG. 10.

FIG. 9 provides an example of the contents displayed by the debugger user interface 610 in a Memory State and Variable Values window 913. The window 913 shows the memory state associated with the program execution in terms of the program variable names (column 920) and their values (column 921) when the program debugger was activated and program execution was stopped. Using the information provided by the exemplary debugger user interface 610 in, a programmer may be able to review the program code and its execution state when a key indicator reached its target criteria and determine a possible cause to the problem.

The subject matter described above is provided by way of illustration only and should not be construed as limiting. Various modifications and substitutions of the described components and operations can be made by those skilled in the art without departing from the spirit and scope of the present invention defined in the following claims, the scope of which is to be accorded the broadest interpretation so as to encompass such modifications and equivalent structures. As will be appreciated by those skilled in the art, the systems, methods, and procedures described herein can be embodied in a programmable computer, computer executable software, or digital circuitry. The software can be stored on computer readable media. For example, computer readable media can include a floppy disk, RAM, ROM, hard disk, removable media, flash memory, a “memory stick”, optical media, magneto-optical media, CD-ROM, etc.

What is claimed is:

1. A computer-implemented method for debugging a computer program, comprising:
establishing a target value for a Key Performance Indicator related to the performance of the program;
enabling a debugger coupled to the program; and
activating the debugger when the Key Performance Indicator reaches the target value during an execution of the program.

2. The method of claim 1, wherein the debugger controls the execution of the program when the debugger is activated.

3. The method of claim 1, wherein the debugger is coupled to an interface to allow a user to control the execution of the program and examine a program execution state.

4. The method of claim 1, wherein the debugger provides a system memory execution state of the program when the debugger is activated.

5. The method of claim 4, wherein the program execution state includes contents of system registers and data structures associated with the program.

6. The method of claim 1, wherein the debugger allows contents of system registers and data structures associated with the program to be monitored and modified.

7. The method of claim 1, wherein the debugger allows a breakpoint to be set against a line of code in the program.

8. The method of claim 1, wherein the debugger allows code lines in the program to be modified.

9. The method of claim 1, wherein the debugger is capable of executing the program in a single-step mode.

10. The method of claim 1, wherein the Key Performance Indicator relates to a rate of transactions being processed in a transaction-processing system.

11. The method of claim 1, wherein the Key Performance Indicator relates to a processing rate of a system processor.

12. The method of claim 1, wherein the Key Performance Indicator relates to a usage rate of a computer resource.

13. The method of claim 1, wherein the Key Performance Indicator relates to a network bandwidth.

14. The method of claim 1, wherein the Key Performance Indicator relates to a rate of client requests being processed in a client-server system.

15. The method of claim 1, wherein the Key Performance Indicator relates to a rate of server responses being processed in a client-server system.

16. A system for debugging a computer program, comprising:
a component for establishing a target value for a Key Performance Indicator related to the performance of the program;
a component for enabling a debugger coupled to the program; and
a component for activating the debugger when the Key Performance Indicator reaches the target value during an execution of the program.

17. The system of claim 16, further comprising a user interface coupled to the debugger for a user to control the execution of the program and examine a program execution state.

18. The system of claim 16, wherein the debugger provides a system memory execution state of the program when the debugger is activated.

19. The system of claim 16, the debugger allows contents of system registers and data structures associated with the program to be monitored and modified.

20. A computer program product for debugging a program, the product having a computer readable storage comprising program code operable to establish a target value for a Key Performance Indicator related to the performance of the program, enable a debugger coupled to the program, and activate the debugger when the Key Performance Indicator reaches the target value during execution of the program.

21. The computer program product of claim 20, wherein the debugger controls the execution of the program when the debugger is activated.

22. The computer program product of claim 20, wherein the debugger is coupled to an interface to allow a user to control the execution of the program and examine a program execution state.

23. The computer program product of claim 20, wherein the debugger provides a system memory execution state of the program when the debugger is activated.

24. The computer program product of claim 23, wherein the program execution state includes contents of system registers and data structures associated with the program.

25. The computer program product of claim 20, wherein the debugger allows contents of system registers and data structures associated with the program to be monitored and modified.
